(19) United States
(12) Patent Application Publication
(10) Pub. No.: US 2016/0118811 A1
(43) Pub. Date: Apr. 28, 2016

(54) POWER TRANSMITTING APPARATUS, CONTROL METHOD, AND STORAGE MEDIUM

(71) Applicant: CANON KABUSHIKI KAISHA, Ohta-ku, Tokyo (JP)

(72) Inventor: Tadashi Eguchi, Tokyo (JP)

(21) Appl. No.: 14/890,115

(22) PCT Filed: May 29, 2014
(86) PCT No.: PCT/JP2014/064897

§ 371 Date: Nov. 9, 2015

(30) Foreign Application Priority Data
Jun. 26, 2013 (JP) 2013-134213

(51) Int. Cl. H02J 5/00

(52) U.S. Cl. CPC H02J 5/005

(57) ABSTRACT

A power transmitting apparatus that wirelessly transmits power to a power receiving apparatus detects whether the amount of the variation is greater than a predetermined amount, and in the case where a variation in the total amount of power is greater than the predetermined amount, carries out control that stops the power transmission or suppresses the transmitted power to no more than a predetermined power. The power transmitting apparatus then identifies a power receiving apparatus that is present in a power-transmittable range of the power transmitting apparatus and that is to receive power, and identifies an amount of power to be received by the power receiving apparatus, while the power transmission is stopped or the transmitted power is suppressed. The power transmitting apparatus then resumes power transmission to the specified power receiving apparatus at the identified amount of power.

### TECHNICAL FIELD

The present invention relates to wireless power transfer techniques.

### BACKGROUND ART

Widespread research and development of wireless power transfer techniques has been underway since wireless power transfer using magnetic resonance was successfully demonstrated in 2007. Wireless power transfer is also garnering attention as a technique that, when combined with wireless communication, enables wires to be removed from devices without worrying about how to charge the devices, for example (“Wireless technology developed to transmit power lights up a 60 W bulb in tests”, Nikkei Electronics, Vol. 966, Dec. 3, 2007).

Furthermore, wireless power transfer techniques continue to spread in a variety of applications, such as charging electric automobiles and hybrid automobiles, charging small electronic devices such as smartphones, and so on. In this context, techniques for transmitting power without inconvenience are also being established. Japanese Patent Laid-Open No. 2011-10384 discloses a power transmitting apparatus that detects the arrival and removal of a power receiving apparatus as well as a positional relationship between the power transmitting and receiving apparatuses. Meanwhile, Japanese Patent Laid-Open No. 2010-284006 discloses a technique that determines conditions where transferring power is inappropriate and does not start power transmission or stops power transmission based on the conditions.

A case such as that shown in FIG. 8, where power is transmitted from a single power transmitting apparatus to a plurality of power receiving apparatuses, can be considered as an example of actual operation of a wireless power transfer system. FIG. 9 is a block diagram illustrating an example of the internal configuration of a typical power transmitting apparatus. In FIG. 9, 901 indicates a constant voltage source that serves as a power source for a class E amp 902. 903 indicates a choke coil that prevents power converted to AC by the class E amp 902 from returning to the DC constant voltage source 901, whereas 904 and 905 indicate resonant capacitors that resonate with a resonant coil 906. 907 and 908 indicate matching elements for a power transmission antenna coil 909. 910 indicates a control unit, such as a CPU, that controls the constant voltage source, an oscillator 911 of the class E amp 902, and so on. In this type of circuit, the CPU 910 adjusts the voltage of the constant voltage source 901 so that a current required by the class E amp 902 can be supplied from at least one of the outputs of a voltage detection function and a current detection function (not shown) provided in the constant voltage source.

Next, a case where a state has changed from that shown in the upper half of FIG. 8, in which a power transmitting apparatus 801 is transmitting power to two power receiving apparatuses 802 and 803, to that shown in the bottom half of FIG. 8, where the power receiving apparatus 803 has been removed, will be considered. FIG. 10 shows an example of variation in an output voltage of the constant voltage source 901 and an AC voltage in the power transmission antenna coil in the power transmitting apparatus 801, and variation in an AC voltage of a power reception antenna coil in the power receiving apparatus 802 that has not been removed, that occur at this time. In FIG. 10, a dotted line indicates a DC output voltage of the constant voltage source 901 in the power transmitting apparatus 801, a thin solid line indicates the AC voltage at the power transmission antenna coil, and a bold solid line indicates the AC voltage at the power reception antenna coil of the power receiving apparatus 802 that has not been removed. A state (1) indicates a period in which the two power receiving apparatuses 802 and 803 are receiving power, and a time t0 indicates a time at which the power receiving apparatus 803 is removed. A state (3) indicates a period in which power is being supplied in a stable manner to the power receiving apparatus 802 after the power receiving apparatus 803 has been removed, and a state (2) indicates a period of transition from state (1) to state (3).

While power is being transmitted to the two power receiving apparatuses 802 and 803, the power that was to be supplied to the removed power receiving apparatus 803 becomes a surplus immediately after the time t0 at which the power receiving apparatus 803 is removed, resulting in a state of overvoltage in the power transmission antenna coil and the class E amp of the power transmitting apparatus 801. Because the power transmission current drops due to the power transmitted to the removed power receiving apparatus 803 and the resulting surplus power, the CPU 910 reduces the voltage of the constant voltage source 901 (a time t1). Thereafter, the CPU adjusts the voltage of the constant voltage source 901 in accordance with a current value required for transmitting power to the power receiving apparatus 802 that has not been removed (a time t2).

At this time, the AC voltage at the power transmission antenna coil rises as indicated by the thin solid line due to the overvoltage, then begins to drop as the output of the constant voltage source 901 drops, and is adjusted to the voltage indicated in the stable state (3). Because the power reception antenna coil of the power receiving apparatus 802 that has not been removed is in a one-to-one relationship with the power transmission antenna coil of the power transmitting apparatus immediately after the power receiving apparatus 803 is removed and thus couples at a mutual inductance m, the voltage at the power reception antenna coil of the power receiving apparatus 802 at this time enters a state of overvoltage. The voltage occurring in the overvoltage state after the power receiving apparatus 803 has been removed is particularly high in the case where the power receiving apparatus 803 that is removed has been receiving a large amount of power and the power receiving apparatus 802 that is not removed has been receiving a small amount of power. In this case, the power reception antenna coil, a matching element, a rectifier circuit, and so on in the power receiving apparatus 802 that has not been removed, and a constant voltage source connected to the rectifier circuit, may be damaged due to the overvoltage. In addition to cases where power is being transmitted to a plurality of power receiving apparatuses and a power receiving apparatus that is receiving power is removed, the amount of power transmitted from the power transmitting apparatus can also vary drastically due to a driving apparatus such as a motor that is carrying out positional control being switched from a driving state to a stopped state and so on. Accordingly, it has been possible for other power receiving apparatuses to be damaged due to overvoltage in cases where power is being supplied to other apparatuses as well.

According to the technique disclosed in Japanese Patent Laid-Open No. 2011-10384, a method for detecting the arrival of a power receiving apparatus, the removal of a power receiving apparatus, a positional relationship between a power transmitting apparatus and a power receiving apparatus, and so on includes selecting a threshold used to determine the arrival and removal of a power receiving apparatus based on the purpose of the detection and the amount of power transmitted. Meanwhile, according to the technique disclosed in Japanese Patent Laid-Open No. 2010-284006, power transmission is not started or power transmission is stopped in the case where an ID authentication for the power receiving apparatus has failed or a foreign object has been detected, the case where the power receiving apparatus is in an improper position, the case where the removal of a power receiving apparatus to which power is being transmitted has been detected, the case where charging is complete, and so on.

However, Japanese Patent Laid-Open No. 2011-10384 and Japanese Patent Laid-Open No. 2010-284006 do not take into consideration a situation such as that described above, where when power is being transmitted from a power transmitting apparatus to a plurality of power receiving apparatuses, the amount of power received by a single power receiving apparatus varies greatly and overvoltage can occur in the power receiving apparatus.

Having been achieved in light of the aforementioned problems, the present invention prevents an excessive voltage from being inputted to a power receiving apparatus during wireless power transfer.

### SUMMARY OF INVENTION

According to one aspect of the present invention, there is provided a power transmitting apparatus that wirelessly transmits power to at least one power receiving apparatus, the power transmitting apparatus comprising: detection means for detecting, in the case where a total amount of power being received by the at least one power receiving apparatus has varied, whether the amount of the variation is greater than a predetermined amount; control means for carrying out control that stops the power transmission to the at least one power receiving apparatus or suppresses the transmitted power to no more than a predetermined power in the case where a variation in the total amount of power that is greater than the predetermined amount has been detected; and identification means for identifying a power receiving apparatus that is present in a power-transmittable range of the power transmitting apparatus and that is to receive power from the power transmitting apparatus, and identifying an amount of power to be received by the power receiving apparatus, while the power transmission is stopped or the transmitted power is suppressed to no more than a predetermined power, wherein the control means further resumes power transmission to the identified power receiving apparatus at the identified amount of power to be received after the identification has been carried out.

Further features of the present invention will become apparent from the following description of an exemplary embodiment (with reference to the attached drawings).

### BRIEF DESCRIPTION OF DRAWINGS

The accompanying drawings, which are incorporated in and constitute a part of the specification, illustrate embodiments of the invention, and together with the description, serve to explain the principles of the invention.

FIG. 1 is a block diagram illustrating an example of the configuration of a wireless power transfer system.

FIG. 2 is a flowchart illustrating an example of processing executed by a power transmitting apparatus.

FIG. 3 is a flowchart illustrating an example of processing executed by a power receiving apparatus.

FIG. 4 is a diagram illustrating an example of variations in an AC voltage at a power transmission antenna coil, an output DC voltage from a constant voltage source in the power transmitting apparatus, and an AC voltage at a power reception antenna coil of a power receiving apparatus that remains, in the wireless power transfer system according to the embodiment.

FIG. 5 is a block diagram illustrating another example of the configuration of a wireless power transfer system.

FIG. 6 is a flowchart illustrating another example of processing executed by the power transmitting apparatus.

FIG. 7 is a flowchart illustrating another example of processing executed by the power receiving apparatus.

FIG. 8 is a diagram illustrating an example of the configuration of a system that transfers power wirelessly.

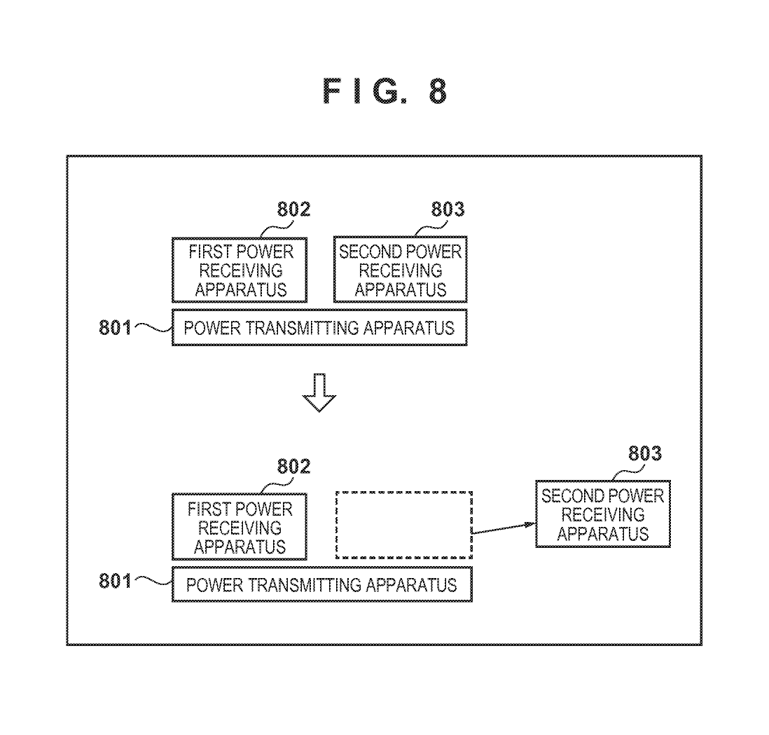

FIG. 9 is a block diagram illustrating an example of the configuration of a conventional power transmitting apparatus.

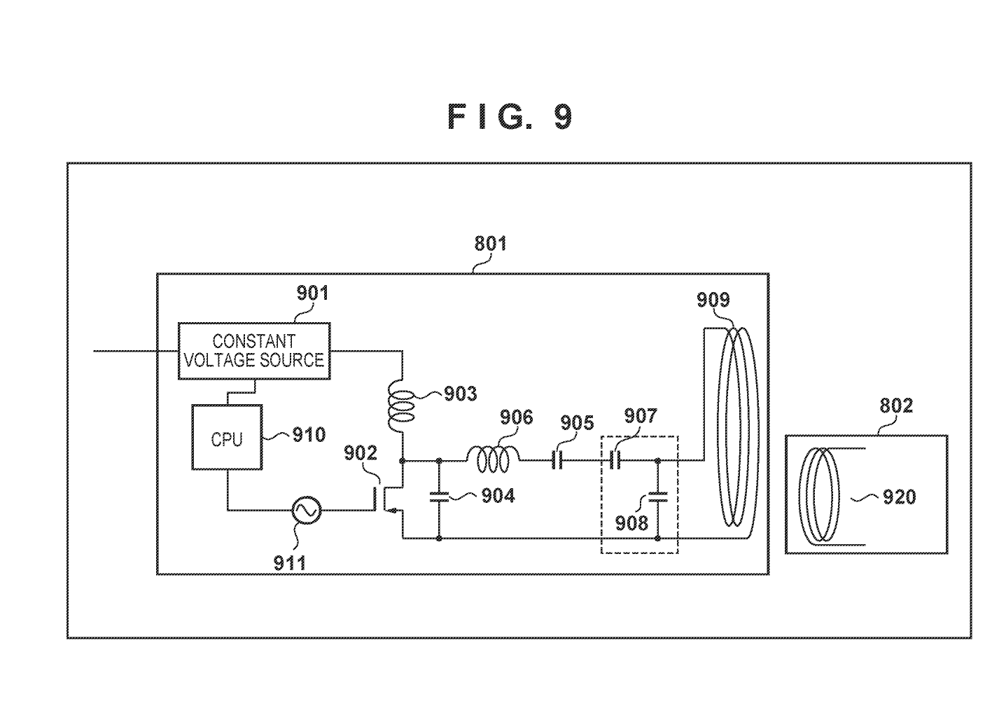

FIG. 10 is a diagram illustrating an example of variations in an AC voltage at a power transmission antenna coil, an output DC voltage from a constant voltage source in the power transmitting apparatus, and an AC voltage at a power reception antenna coil of a power receiving apparatus that remains, in the conventional wireless power transfer system.

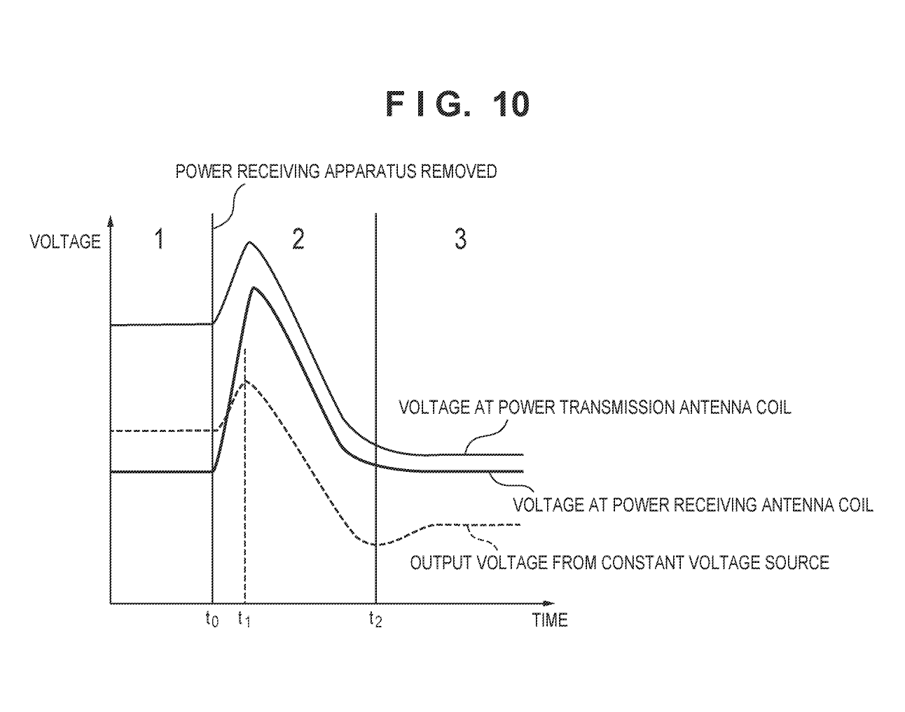

### DESCRIPTION OF EMBODIMENTS

An exemplary embodiment of the present invention will now be described in detail with reference to the drawings. It should be noted that the relative arrangement of the components, the numerical expressions, and numerical values set forth in the embodiment do not limit the scope of the present invention unless it is specifically stated otherwise.

System and Apparatus Configuration

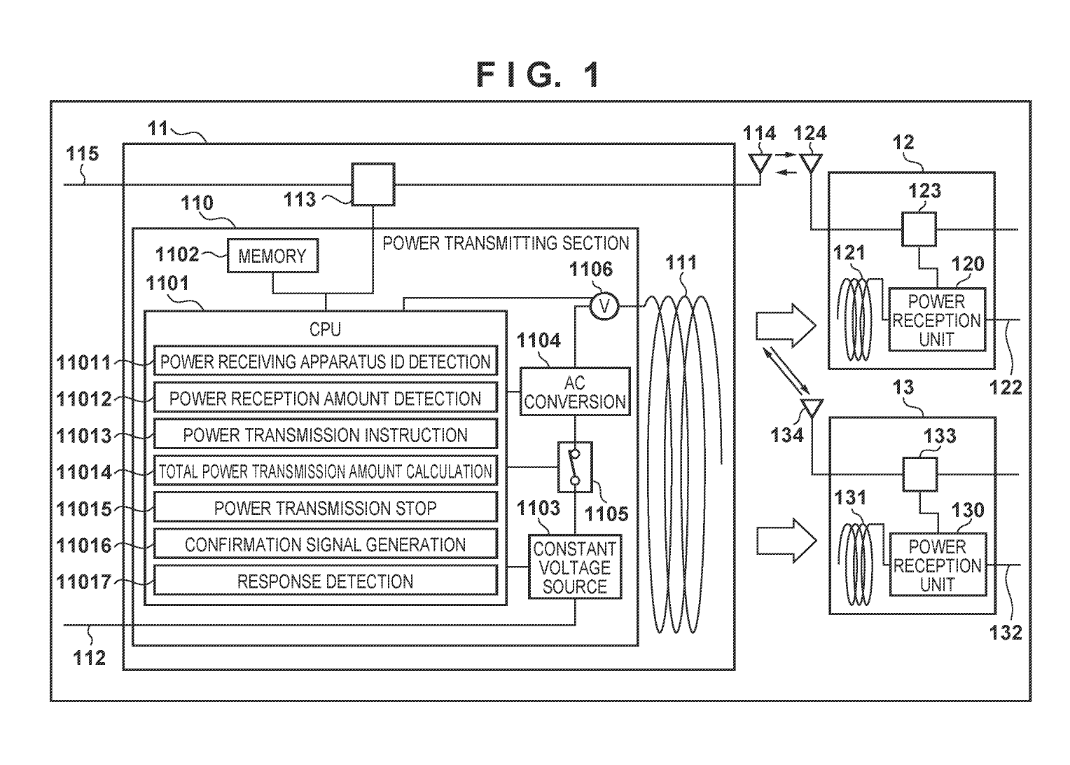

FIG. 1 is a block diagram illustrating an example of a wireless power transfer system according to the present embodiment, as well as the internal configurations of a power transmitting apparatus 11 and power receiving apparatuses 12 and 13 included in the wireless power transfer system. The power transmitting apparatus 11 and the power receiving apparatuses 12 and 13 include communication units 113, 123, and 133, respectively, that have communication functions based on Bluetooth®, for example, and communicate wirelessly with each other by transmitting and receiving electromagnetic waves to and from an antenna 114 and an antenna 124 or 134, respectively.

In the power transmitting apparatus 11, 110 indicates a power transmission section that converts DC or AC power input from a power transmission line 112 into AC-frequency power in a transmission band, and transmits the power to at least one of the power receiving apparatus 12 and the power receiving apparatus 13, for example, via a power transmission antenna coil 111. 120 in the power receiving apparatus 12 and 130 in the power receiving apparatus 13 indicate power reception units that convert AC power received via power reception antenna coils 121 and 131, respectively, into DC or AC power in a desired frequency, and output the power to power transmission lines 122 and 132, respectively.

Power is transmitted over a long distance particularly when transmitting power using a resonance phenomenon, microwaves, or the like, and thus it is necessary to pair power transmitting apparatuses with power receiving apparatuses and transmit power to a desired apparatus while preventing power from being transmitted to other apparatuses and objects. Accordingly, the power receiving apparatuses 12 and 13 that are to receive power search out a power transmitting apparatus that is capable of transmitting power via the communication units 123 and 133, and carry out pairing with the communication unit 113 of a power transmitting apparatus that has been found (that is, the power transmitting apparatus 11). For example, identification information (IDs) for identifying the power receiving apparatuses are exchanged between the communication unit 113 of the power transmitting apparatus 11 and the communication unit 123 of the power receiving apparatus 12 and between the communication unit 113 of the power transmitting apparatus 11 and the communication unit 133 of the power receiving apparatus 13.

In the power transmission section 110, 1103 indicates a constant voltage source, and the power to be transmitted is adjusted by a CPU 1101 in accordance with the power required for power reception. 1105 indicates a power transmission amount limiting unit, which is configured of, for example, a current limiting circuit, a voltage limiting circuit, an ON/OFF circuit that uses a switching element, or the like. The power transmission amount limiting unit 1105 is controlled to cut the supply of power from the constant voltage source 1103 to an AC conversion unit 1104 or reduce the transmitted power when overvoltage is detected, in order to protect the circuitry of the power receiving apparatuses. In the present embodiment, it is assumed that, for example, an ON/OFF circuit that uses a switching element is employed as the power transmission amount limiting unit 1105, and thus the following will refer to the power transmission amount limiting unit as a “switch”. Note that the transmitted power may be limited by controlling the constant voltage source 1103, for example.

1104 indicates an AC conversion unit, which converts DC power or AC power from an AC outlet or the like into a frequency for power transmission. 1106 indicates an AC voltmeter that detects a voltage at the power transmission antenna coil 111 and the AC conversion unit 1104. 1102 indicates a memory in which is stored the identification information (IDs) of power receiving apparatuses obtained from device authentication carried out through the communication unit 113.

Here, the CPU 1101 functions as at least one of an ID detecting unit 11011, a power reception amount detecting unit 11012, a power transmission instructing unit 11013, a total power transmission amount calculating unit 11014, a power transmission stopping unit 11015, a confirmation signal generating unit 11016, and a response detecting unit 11017, for example.

The ID detecting unit 11011 detects the identification information (IDs) that identify the power receiving apparatuses. When the power transmitting apparatus 11 transmits power to at least one of the power receiving apparatuses, the ID detecting unit 11011 detects information identifying the power receiving apparatus that serves as the power transmission partner, and identifies that power receiving apparatus as a power transmission target. Note that the power receiving apparatus is identified by, for example, acquiring the ID of the power receiving apparatus in an initial authentication carried out during wireless power transfer. Meanwhile, in a state where power transmission is stopped or the transmitted power is suppressed to no more than a predetermined amount of power, which will be described later, the ID of the power receiving apparatus is detected from a power transmission request signal from the power receiving apparatus or from a response to a confirmation signal confirming that the power receiving apparatus is in a power-transmittable range of the power transmitting apparatus in which power can be transmitted from the power transmitting apparatus to the power receiving apparatus.

The power reception amount detecting unit 11012 detects and identifies the power received by at least one of the power receiving apparatuses that serves as a partner apparatus for the wireless power transfer. Through this, the power transmitting apparatus 11 determines how much power should be transmitted, and adjusts the voltage of the constant voltage source 1103. The power transmission instructing unit 11013 outputs an instruction that, for example, turns the switch 1105 on, so that power transmission is started in a state where wireless power transfer is possible, or in other words, in a state where overvoltage is not being applied to the power receiving apparatus.

On the other hand, the power transmission stopping unit 11015 outputs an instruction that, for example, turns the switch 1105 off, so that power transmission is stopped in a state where overvoltage may be applied to the power receiving apparatus. Here, if the power is reduced to, for example, no more than a minimum received power value in each of at least one of the power receiving apparatuses, or to a predetermined amount of power less than the minimum received power value, overvoltage will not be applied to the power receiving apparatus even in a state where it is possible that overvoltage will be applied to the power receiving apparatus. For example, in the case where the power received by a first power receiving apparatus is 5.5 watts (W) and the power received by a second power receiving apparatus is 13.5 W, suppressing the transmitted power to no more than 5.5 W ensures that even if one of the power receiving apparatuses is removed, overvoltage will not be applied to the remaining power receiving apparatus. Accordingly, the power transmission stopping unit 11015 may limit the current or voltage and suppress the transmitted power to no more than a predetermined amount of power instead of turning the switch 1105 off. Furthermore, the transmitted power may be suppressed to no more than a predetermined amount of power by controlling the voltage of the constant voltage source 1103.

The total power transmission amount calculating unit 11014 calculates a total amount of power received by each of at least one of the power receiving apparatuses as a total power transmission amount. The confirmation signal generating unit 11016 and the response detecting unit 11017 provide a trigger for resuming power transmission after the power transmission has been stopped or suppressed to no more than a predetermined amount of power. Specifically, for each power receiving apparatus that has thus far been a power transmission destination, the confirmation signal generating unit 11016 generates a confirmation signal confirming that the power receiving apparatus is in the power-transmittable range and confirming whether to continue the power reception. The generated confirmation signal is transmitted to the power receiving apparatuses present in the power-transmittable range. Thereafter, the response detecting unit 11017 detects whether a response signal has been received from the power receiving apparatus that received the confirmation signal.

Then, for the power receiving apparatus that received the response signal, the total power transmission amount calculating unit 11014, for example, identifies the received power requested by that power receiving apparatus based on information contained in the response signal, for example. Specifically, in the case where, for example, the response signal contains information directly identifying the requested received power, the total power transmission amount calculating unit 11014 identifies the requested received power from that information. Meanwhile, in the case where the response signal contains information instructing the received power to increase or decrease relative to the power received up until that point, the total power transmission amount calculating unit 11014 may identify the requested received power based on the power received up until that point and the stated information. Thereafter, for example, the total power transmission amount calculating unit 11014 adjusts the transmitted power by controlling the voltage of the constant voltage source 1103 so as to supply the total amount of the received power requested by all of the power receiving apparatuses that are the sources of the response signals. The power transmission instructing unit 11013 then turns the switch 1105 on, and power transmission to the remaining power receiving apparatus is started. Through this, in the case where some of the power receiving apparatuses have been removed and the power transmission is stopped or suppressed, the power transmission can be quickly resumed at the power requested by the remaining power receiving apparatus.

Processing of Power Transmitting Apparatus

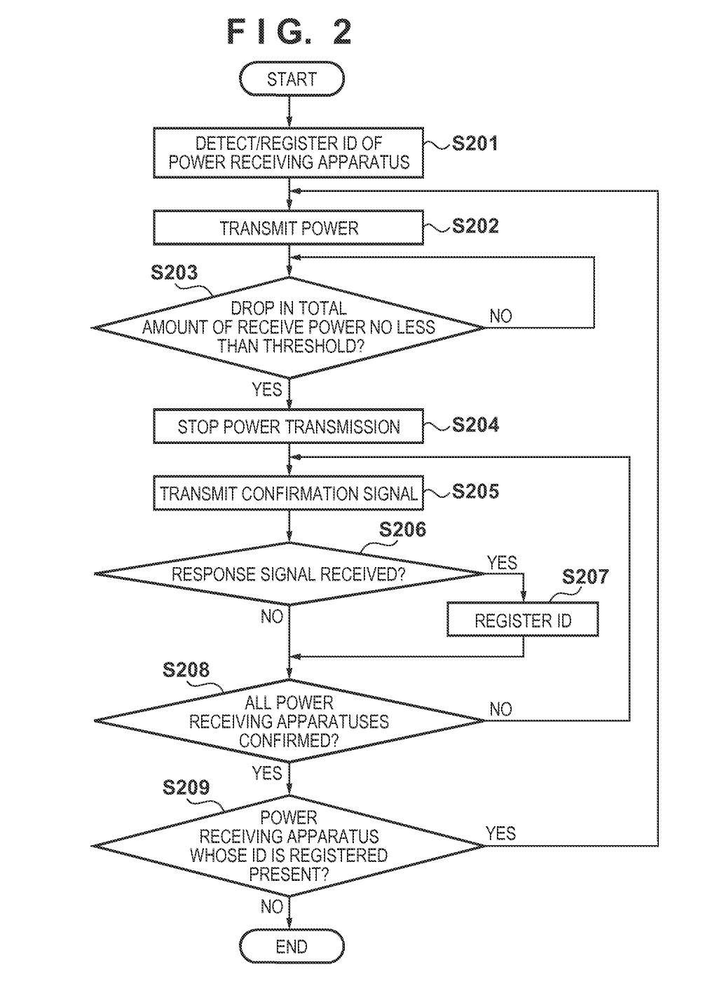

FIG. 2 is a flowchart illustrating an example of processing executed by the power transmitting apparatus 11. In the wireless power transfer system, the power transmitting apparatus starts power transmission after identifying the power transmission partner by confirming the identification information (IDs) of the power receiving apparatuses and so on. Likewise, the power receiving apparatus receives power after identifying the partner from which power is to be received by confirming the identification information of the power transmitting apparatus and so on. The power transmitting apparatus, which is capable of transmitting power to a plurality of power receiving apparatuses, exchanges the identification information with a power receiving apparatus each time a power receiving apparatus is detected within the power-transmittable range, registers the identification information (IDs) of the power receiving apparatuses that are to be power transmission partners (S201), and then starts power transmission (S202).

After starting the power transmission, the power transmitting apparatus 11 monitors the total amount of power received by each of at least one power receiving apparatus (S203). In the case where the total amount of received power has varied, the power transmitting apparatus 11 determines whether the amount of variation is greater than a predetermined amount. Specifically, for example, it is detected that a diminution in the total amount of received power is equal to or greater than a predetermined amount. Then, in the case where the power transmitting apparatus 11 has detected the total amount of received power as varying no less than a predetermined amount (YES in S203), the power transmission is stopped (S204).

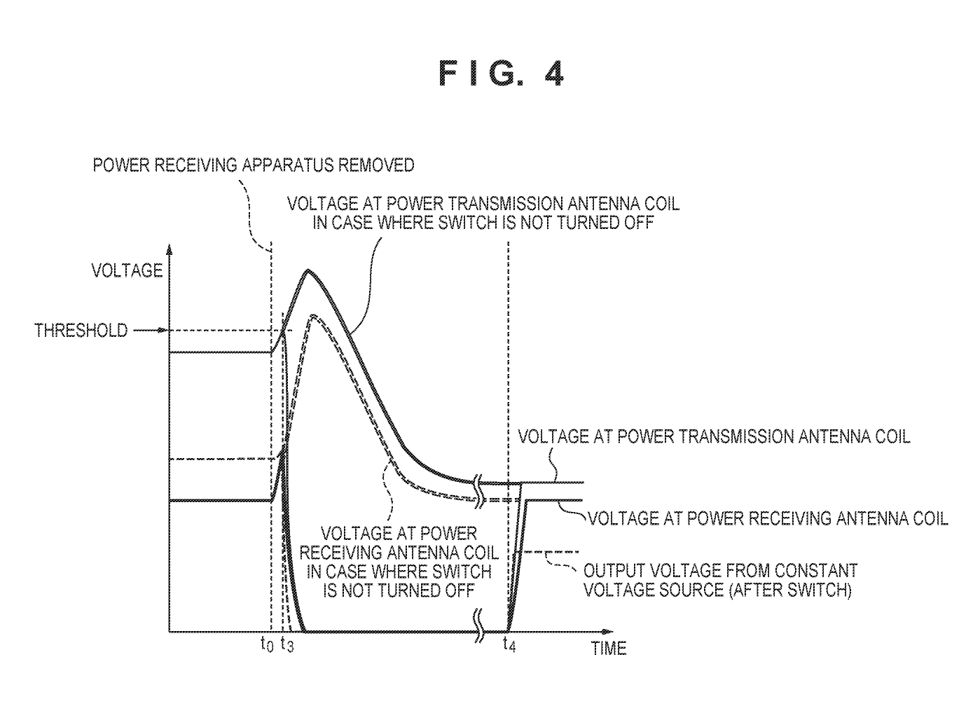

FIG. 4 is a graph illustrating an example of variations in the AC voltage at the power transmission antenna coil 111, the output DC voltage from the constant voltage source 1103 in the power transmitting apparatus, and the AC voltage at the power reception antenna coil 121 of the power receiving apparatus 12 that remains, according to the present embodiment. In the case where the power has suddenly dropped due to the power receiving apparatus 13 being removed, the current received by the power receiving apparatus, and the total amount of power received, will drop, and the impedance on the power reception side, as viewed from the power transmission antenna coil, will rise. Accordingly, as shown in FIG. 4, the AC voltage at the power transmission antenna coil 111 of the power transmitting apparatus 11 will temporarily rise. At this time, the AC voltmeter 1106 of the power transmitting apparatus 11 detects the rise in the voltage, and in the case where the amount of the rise is greater than or equal to a threshold, the CPU 1101 turns the switch 1105 off.

In this manner, the power transmitting apparatus 11 can determine whether the total amount of power received by the power receiving apparatus has dropped no less than a predetermined amount based on the amount of the rise in the voltage, and control for stopping the power transmission can then be executed based on the result of the determination. Likewise, it may be determined whether the total amount of received power has dropped no less than a predetermined amount based on a result of monitoring the manner in which the transmitted power varies. Here, the AC voltage at the power reception antenna coil 121 of the power receiving apparatus 12 drops to 0 V when the switch 1105 is turned off. Accordingly, the power reception section of the power receiving apparatus 12 can be prevented from being damaged by overvoltage. Note that the power transmitting apparatus 11 may reduce the transmitted power to no more than a predetermined voltage rather than stopping the power transmission. The “predetermined voltage” at this time may be, for example, a power no more than the lowest value among the power received by the respective power receiving apparatuses.

After stopping all power transmission using the switch 1105, the power transmitting apparatus 11 transmits, via the communication unit 113, the confirmation signal confirming whether the power receiving apparatus is within the power-transmittable range and whether power reception will be continued, to all of the power receiving apparatuses to which power has been transmitted to up until that point (S205). The power receiving apparatus 12 returns the response signal as a response to the confirmation signal to the power transmitting apparatus 11, whereas the power receiving apparatus 13 that has been removed does not respond. Here, when responding to the confirmation signal, the power receiving apparatus 12 transmits information indicating the requested received power. In the case where the power transmitting apparatus 11 has received the response signal responding to the confirmation signal (YES in S206), the power transmitting apparatus 11 registers the ID of the power receiving apparatus that transmitted the response signal (S207), but does not register IDs for the power receiving apparatus from which the response signal has not been detected (NO in S206). Then, in the case where, after transmitting the confirmation signal to all of the power receiving apparatuses that have been power transmission destinations up to that point (YES in S208), there is a power receiving apparatus whose ID is registered (YES in S209), the power transmitting apparatus 11 controls the constant voltage source 1103 to transmit the total amount of received power requested by the power receiving apparatuses, and resumes the power transmission.

Processing of Power Receiving Apparatus

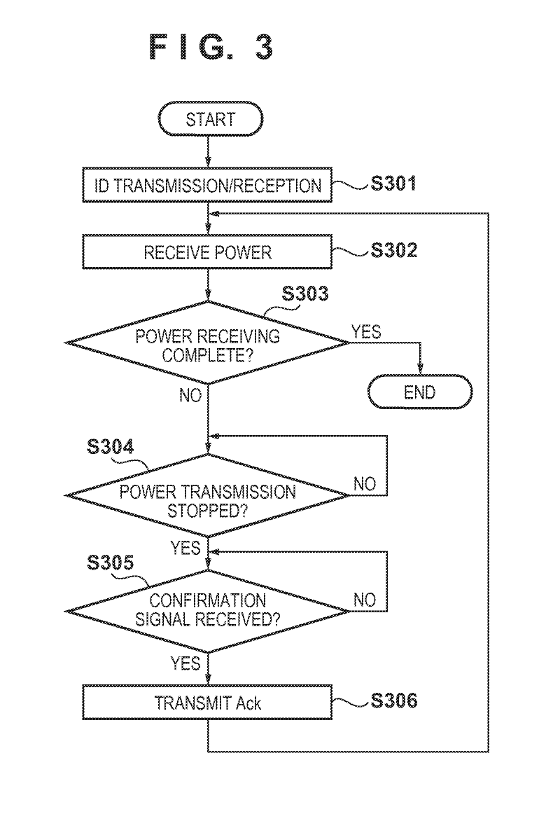

FIG. 3 is a flowchart illustrating an example of processing executed by the power receiving apparatus. After executing at least one of transmitting identification information (an ID) and receiving identification information from the power transmitting apparatus (S301), the power receiving apparatus starts receiving power from the power transmitting apparatus (S302). Then, in the case where the power reception has ended, such as in the case where charging has been completed (YES in S303), the power receiving apparatus ends the processing.

On the other hand, in the case where the power reception has not ended (NO in S303), the power receiving apparatus monitors whether the transmission of power from the power transmitting apparatus 11 has been stopped or whether the transmitted power is being suppressed (S304). In the case where the power transmission has been stopped (YES in S304) or the case where the transmitted power has been suppressed, the power receiving apparatus stands by for the confirmation signal to be transmitted from the power transmitting apparatus 11 (S305). Then, in the case where the power receiving apparatus has received the confirmation signal (YES in S305), the power receiving apparatus transmits a response signal (Ack) including the requested received power (S306). Then, when the power transmission from the power transmitting apparatus 11 is resumed, the processing from S302 on is repeated.

The foregoing has described the power transmitting apparatus identifying the received power requested by the power receiving apparatus based on the response signal when the power transmission is temporarily stopped or suppressed. However, the power transmitting apparatus may, for example, acquire only the identification information of the power receiving apparatus from the response signal and identify, as the requested received power for that power receiving apparatus, an amount of power received up until the power transmission was temporarily stopped or suppressed, that corresponds to the identification information and is stored in the memory 1102 or the like. Furthermore, the power receiving apparatus may include information indicating whether to increase or decrease the received power from the amount of power received up until that point, or indicating an amount of increase or decrease, in the response signal, and the power transmitting apparatus may identify the requested received power based on the amount of power received by the power receiving apparatus up until that point and based on the stated information. Note that in this case, the power receiving apparatus may periodically notify the power transmitting apparatus of the requested received power through the periodic exchange of information or the like.

Furthermore, although the above configuration makes it possible to identify power receiving apparatuses that are present in the power-transmittable range of the power transmitting apparatus and that will continue to receive power by the power transmitting apparatus generating and transmitting the confirmation signal to the power receiving apparatuses and the power receiving apparatuses transmitting response signals in response thereto, the present invention is not limited thereto. For example, the power transmitting apparatus may identify power receiving apparatuses that are present in the power-transmittable range of the power transmitting apparatus and that will continue to receive power by receiving a power transmission request signal from the power receiving apparatuses within a predetermined amount of time after power transmission has been stopped or suppressed to no more than a predetermined power.

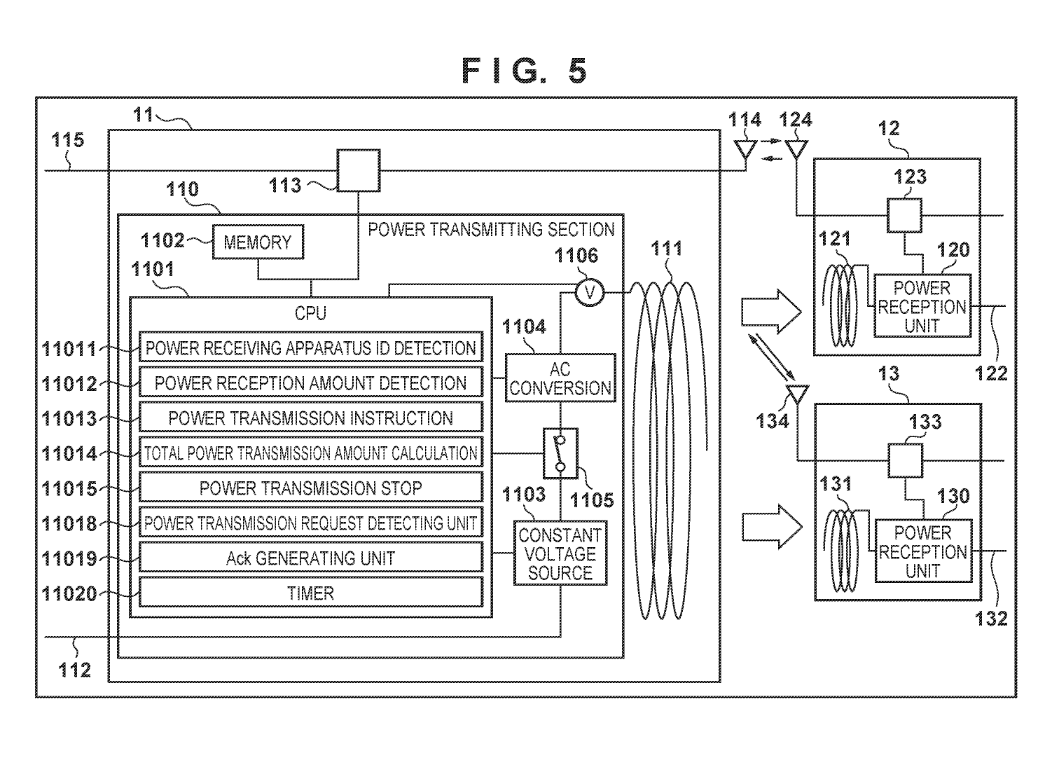

FIG. 5 illustrates an example of the configuration of the wireless power transfer system, and of the power transmitting apparatus in particular, in such a case. As shown in FIG. 5, the power transmitting apparatus 11 in this case includes a power transmission request detecting unit 11018, an Ack generating unit 11019, and a timer 11020 instead of the confirmation signal generating unit 11016 and the response detecting unit 11017. Like the confirmation signal generating unit 11016 and the response detecting unit 11017 shown in FIG. 1, the power transmission request detecting unit 11018, the Ack generating unit 11019, and the timer 11020 serve to provide a trigger for resuming power transmission after the power transmission has been temporarily stopped or the transmitted power has been suppressed.

Specifically, for example, in the case where the power received by the power receiving apparatus 12 that has not been removed has dropped to zero or has decreased despite not issuing a request to stop the power transmission, the power receiving apparatus 12 transmits a power transmission request signal to the power transmitting apparatus 11. The power transmission request detecting unit 11018 receives and detects the power transmission request signal. Then, the Ack generating unit 11019 generates a response signal (Ack) in response to the power transmission request signal, and transmits the response signal to the power receiving apparatus 12, from which the power transmission request signal was transmitted. At this time, the timer 11020 measures a predetermined amount of time, and the power transmission request detecting unit 11018 identifies the power receiving apparatus from which the power transmission request signal has been transmitted within that predetermined amount of time.

Then, for example, based on a result of the detection, the total power transmission amount calculating unit 11014 calculates the total amount of power received by all of the power receiving apparatus from which the power transmission request signal has been transmitted within the predetermined amount of time, and controls the voltage of the constant voltage source 1103. The power transmission instructing unit 11013 then turns the switch 1105 on, and power transmission to the remaining power receiving apparatus is started. Through this, in the case where some of the power receiving apparatuses have been removed and the power transmission is stopped or suppressed, the power transmission can be quickly resumed at the power requested by the remaining power receiving apparatus.

Note that the power receiving apparatus may transmit the requested received power within the power transmission request signal, for example. In this case, for example, the total power transmission amount calculating unit 11014 analyzes the power transmission request signal and calculates the total amount of power received, based on the requested received power from each of the power receiving apparatuses from which the power transmission request signal has been transmitted within the predetermined amount of time. Meanwhile, the power transmitting apparatus may, for example, acquire only the identification information of the power receiving apparatus from the power transmission request signal and identify, as the requested received power for that power receiving apparatus, an amount of power received up until the power transmission was temporarily stopped or suppressed, that corresponds to the identification information and is stored in the memory 1102 or the like. Furthermore, the power receiving apparatus may include information indicating whether to increase or decrease the received power from the amount of power received up until that point, or indicating an amount of increase or decrease, in the power transmission request signal, and the power transmitting apparatus may identify the requested received power based on the amount of power received by the power receiving apparatus up until that point and based on the stated information. Note that in this case, the power receiving apparatus may periodically notify the power transmitting apparatus of the requested received power through the periodic exchange of information or the like.

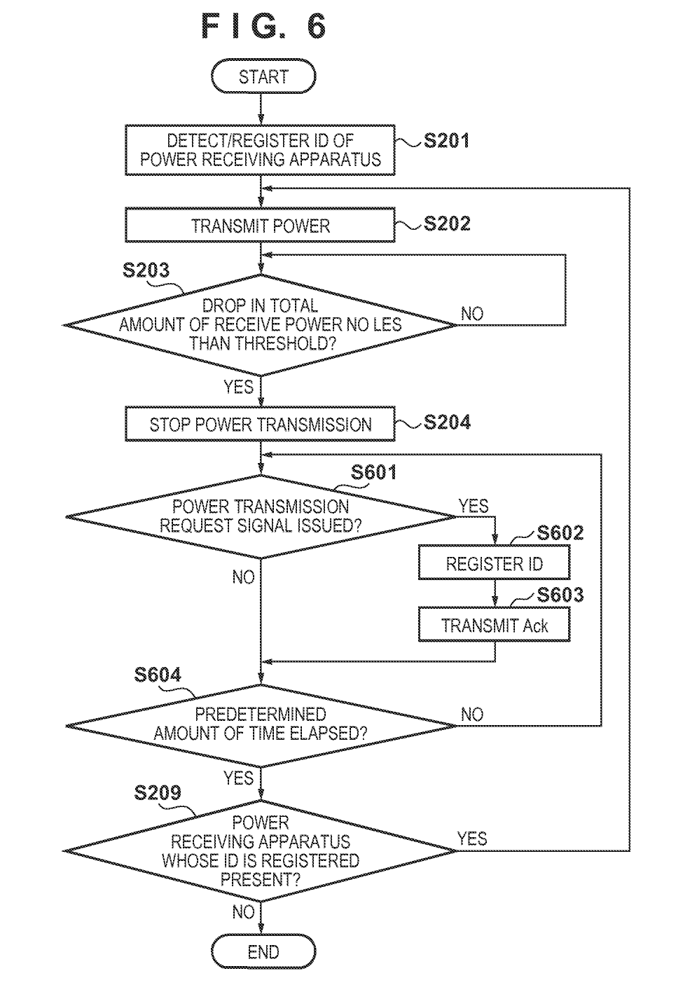

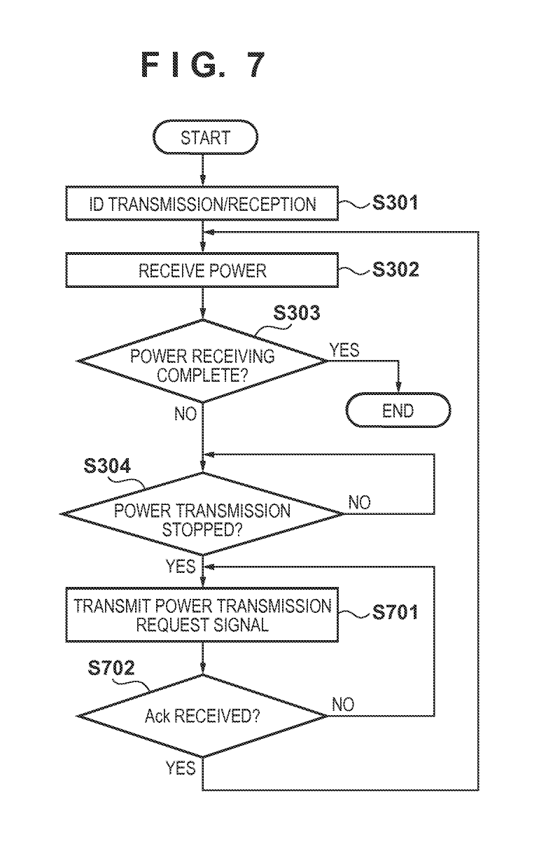

FIG. 6 is a flowchart illustrating a flow of processing executed by the power transmitting apparatus at this time. Likewise, FIG. 7 is a flowchart illustrating a flow of processing executed by the power receiving apparatus at this time. In FIGS. 6 and 7, steps that execute the same processes as those in FIG. 2 or 3 are given the same reference numerals, and descriptions thereof will be omitted.

As shown in FIG. 7, upon detecting that power transmission has stopped or the amount of transmitted power has been suppressed (YES in S304), the power receiving apparatus transmits the power transmission request signal to the power transmitting apparatus (S701). This power transmission request signal includes, for example, an amount of requested received power. After stopping or suppressing the power transmission, the power transmitting apparatus starts the timer 11020 and stands by for the power transmission request signal (S601). Then, upon receiving the power transmission request signal within the predetermined amount of time, the power transmitting apparatus registers the ID of the power receiving apparatus from which the power transmission request signal was transmitted (S602) and transmits an Ack to the power receiving apparatus from which the power transmission request signal was transmitted (S603). Then, when the predetermined amount of time has elapsed (YES in S604), the power transmitting apparatus finishes standing by for the power transmission request signal, and in the case where there is a power receiving apparatus whose ID is registered (YES in S209), the power transmitting apparatus controls the constant voltage source 1103 to transmit the total amount of received power requested by the power receiving apparatuses, and resumes the power transmission. On the other hand, after transmitting the power transmission request signal, the power receiving apparatus stands by for the Ack from the power transmitting apparatus (S702), and after receiving the Ack, resumes the power reception.

Note that in S601, the power transmitting apparatus may stand by for only the power transmission request signal from a power receiving apparatus that has already been a power transmission destination. In other words, the power transmitting apparatus may ignore power transmission request signals from power receiving apparatuses that have not yet been power transmission destinations. This makes it possible to prevent a delay in resuming the power transmission caused by registering new power receiving apparatuses. However, in the case where a power transmission request signal has been received from a new power receiving apparatus that has not yet been a power transmission destination, the power transmitting apparatus may register the new power receiving apparatus and start transmitting power to that power receiving apparatus upon resuming the power transmission.

Although the foregoing describes the power transmitting apparatus as acquiring the identification information that identifies power receiving apparatuses that have already been power transmission destinations while the power transmission is stopped or the transmitted power is suppressed and resuming the supply of power to the power receiving apparatuses corresponding to that identification information, the same device authentication as in the initial authentication may be executed once again instead. Through this, the power transmitting apparatus can resume the power transmission having identified the power receiving apparatus with certainty. Furthermore, a simplified authentication that is different from the initial authentication, such as simply confirming the identification information (ID), may be executed when resuming the supply of power. This makes it possible to reduce the amount of processing performed when resuming power transmission, which in turn makes it possible to quickly resume the power transmission.

Furthermore, although the foregoing has described the communication between the power transmitting apparatus and the power receiving apparatuses as employing a separate communication function unrelated to the wireless power transfer, the communication may instead be carried out with power transmission signals used for the wireless power transfer by employing load modulation or the like. Doing so makes it possible to simplify the configurations of the power transmitting apparatus and the power receiving apparatuses.

Through the above operations, a state in which overvoltage may be applied is detected by monitoring the degree of variation in the total amount of received power, and the power transmission is temporarily stopped or the amount of power transmitted is suppressed to no more than a predetermined amount of power in accordance with the detection. The received power requested by the power receiving apparatus that will continue to receive power is identified while the power transmission is temporarily stopped or suppressed, and the power transmission is resumed after controlling the transmitted power in accordance with the requested received power that has been specified. As a result, overvoltage will not be applied to the power receiving apparatus, and the chance of the apparatus being damaged can be reduced.

According to the present invention, an excessive voltage can be prevented from being inputted to a power receiving apparatus during wireless power transfer.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of the above-described embodiment of the present invention, and by a method performed by the computer of the system or apparatus by, for example, reading out and executing the computer executable instructions from the storage medium to perform the functions of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-134213, filed Jun. 26, 2013, which is hereby incorporated by reference herein in its entirety.

1. A power transmitting apparatus that wirelessly transmits power to at least one power receiving apparatus, the power transmitting apparatus comprising:
a detection unit configured to detect, in the case where a total amount of power being received by the at least one power receiving apparatus has varied, whether the amount of the variation is greater than a predetermined amount;
a control unit configured to carry out control that stops the power transmission to the at least one power receiving apparatus or suppresses the transmitted power to no more than a predetermined power in the case where a variation in the total amount of power that is greater than the predetermined amount has been detected; and
an identification unit configured to identify a power receiving apparatus that is present in a power-transmittable range of the power transmitting apparatus and that is to receive power from the power transmitting apparatus, and identify an amount of power to be received by the power receiving apparatus, while the power transmission is stopped or the transmitted power is suppressed to no more than a predetermined power,
wherein the control unit further resumes power transmission to the identified power receiving apparatus at the identified amount of power to be received after the identification has been carried out.

2. The power transmitting apparatus according to claim 1, further comprising:
a transmitting unit configured to transmit a confirmation signal to the power receiving apparatus that is present in the power-transmittable range,
wherein the identification unit identifies the power receiving apparatus that is present in the power-transmittable range and that is to receive power from the power transmitting apparatus by receiving a response to the confirmation signal from the power receiving apparatus.

3. The power transmitting apparatus according to claim 2,
wherein the identification unit identifies the amount of power to be received by the power receiving apparatus that is to receive power from the power transmitting apparatus based on information contained in the response.

4. The power transmitting apparatus according to claim 1,
wherein the identification unit identifies the power receiving apparatus that is present in the power-transmittable range and that is to receive power from the power transmitting apparatus by receiving a request signal from the power receiving apparatus that is present in the power-transmittable range.

5. The power transmitting apparatus according to claim 4,
wherein the identification unit identifies the amount of power to be received by the power receiving apparatus that is to receive power from the power transmitting apparatus based on information contained in the request signal.

6. The power transmitting apparatus according to claim 1,
wherein the detection unit detects whether the total amount of power has varied by an amount that is greater than the predetermined amount by monitoring a power transmission amount in the power transmitting apparatus.

7. The power transmitting apparatus according to claim 1,
wherein the detection unit detects whether the total amount of power has varied by an amount that is greater than the predetermined amount by monitoring a voltage at an antenna of the power transmitting apparatus that transmits power.

8. The power transmitting apparatus according to claim 1, further comprising:
an acquiring unit configured to acquire identification information that identifies the at least one power receiving apparatus,
wherein the identification unit specifies, of the at least one power receiving apparatus, a power receiving apparatus that is present in the power-transmittable range and that is to receive power from the power transmitting apparatus based on the identification information.

9. The power transmitting apparatus according to claim 1, further comprising:
an acquiring unit configured to acquire identification information that identifies the at least one power receiving apparatus and information indicating the amount of power received by the at least one power receiving apparatus,
wherein the identification unit specifies, of the at least one power receiving apparatus, a power receiving apparatus that is present in the power-transmittable range and that is to receive power from the power transmitting apparatus based on the identification information, and identifies the amount of power to be received by the identified power receiving apparatus based on the information indicating the amount of power received.

10. The power transmitting apparatus according to claim 9,
where the information indicating the amount of power received is periodically communicated from the at least one power receiving apparatus.

11. The power transmitting apparatus according to claim 8, further comprising:
an authentication unit configured to authenticate the at least one power receiving apparatus using the identification information before power is transmitted to the at least one power receiving apparatus.

12. The power transmitting apparatus according to claim 11,
wherein prior to resuming power transmission, the authentication unit authenticates the identified power receiving apparatus using a simpler form of authentication than an initial authentication performed on the power receiving apparatus.

13. A control method for a power transmitting apparatus that wirelessly transmits power to at least one power receiving apparatus, the method comprising:
detecting, in the case where a total amount of power being received by the at least one power receiving apparatus has varied, whether the amount of the variation is greater than a predetermined amount;
carrying out control that stops the power transmission to the at least one power receiving apparatus or suppresses the transmitted power to no more than a predetermined power in the case where a variation in the total amount of power that is greater than the predetermined amount has been detected;
identifying a power receiving apparatus that is present in a power-transmittable range of the power transmitting apparatus and that is to receive power from the power transmitting apparatus, and identifying an amount of power to be received by the power receiving apparatus, while the power transmission is stopped or the transmitted power is suppressed to no more than a predetermined power; and
resuming power transmission to the identified power receiving apparatus at the identified amount of power to be received after the specification has been carried out.

14. A non-transitory computer-readable storage medium storing a computer program that causes a computer in a power transmitting apparatus that wirelessly transmits power to at least one power receiving apparatus to:
detect, in the case where a total amount of power being received by the at least one power receiving apparatus has varied, whether the amount of the variation is greater than a predetermined amount;
carry out control that stops the power transmission to the at least one power receiving apparatus or suppresses the transmitted power to no more than a predetermined power in the case where a variation in the total amount of power that is greater than the predetermined amount has been detected;
identify a power receiving apparatus that is present in a power-transmittable range of the power transmitting apparatus and that is to receive power from the power transmitting apparatus, and identify an amount of power to be received by the power receiving apparatus, while the power transmission is stopped or the transmitted power is suppressed to no more than a predetermined power; and
resume power transmission to the identified power receiving apparatus at the identified amount of power to be received after the specification has been carried out.
